(19) United States
(12) Patent Application Publication
(10) Pub. No.: US 2015/0124381 A1
(43) Pub. Date: May 7, 2015

(54) SWITCHBOARD COPPER BUSBAR HEAT DISSIPATING DEVICE

(71) Applicant: Chia Hsing Electrical Co., Ltd., Taoyuan County (TW)

(72) Inventor: SEN-CHAN WU, TAOYUAN COUNTY (TW)

(73) Assignee: Chia Hsing Electrical Co., Ltd., Taoyuan County (TW)

(21) Appl. No.: 14/072,355

(22) Filed: Nov. 5, 2013

(51) Int. Cl. H02B 1/56; H02B 1/28

(52) U.S. Cl. CPC H02B 1/56; H02B 1/28
USPC 361/678; 361/677

(57) ABSTRACT

A switchboard copper busbar heat dissipating device for dissipating heat from a copper busbar inside a switchboard includes a thermally-conductive electrically-insulating plate having a first surface connected to the copper busbar and a second surface; at least one heat pipe having a first end connecting to the second surface of the thermally-conductive electrically-insulating plate and a second end protruding out of the switchboard; and a plurality of cooling fins connected to the second end of the heat pipe and disposed outside the switchboard. Hence, the switchboard copper busbar heat dissipating device is conducive to miniaturization of a switchboard, enhancement of efficiency of heat dissipation of the switchboard, compliance with the Ingress Protection (IP) Ratings of the switchboard (regarding waterproofing and dust-proofing thereof), and avoiding a waste of energy.

### FIELD OF THE INVENTION

The present invention relates to heat dissipating devices, and more particularly, to a switchboard copper busbar heat dissipating device for use in dissipating heat from a copper busbar of a switchboard.

### BACKGROUND OF THE INVENTION

A conventional switchboard dissipates heat from a switchboard's interior by convection, using an overhead cooler or a tray-view cooler. Specifically speaking, an inlet fan and an exhaust fan are disposed at the lower half and the upper half of the switchboard, respectively. Cool air outside the switchboard is guided into the switchboard by the inlet fan to enable heat exchange between the heat inside the switchboard and the incoming cool air. The exhaust fan expels the heat-carrying air to thereby achieve heat dissipation and enables the influx of cool air via the inlet fan.

However, it is only when the conventional switchboard has a spacious interior for convection to take place therein that the conventional switchboard can function well, regardless of whether the conventional switchboard is equipped with an overhead cooler or a tray-view cooler.

Furthermore, just because the overhead cooler and the tray-view cooler are capable of heat dissipation, it does not mean that cooling can be effectuated instantly. The reasons are: first, the internal temperature of the switchboard is ever-increasing; second, heat dissipation carried out by the overhead cooler and the tray-view cooler slows down at a high ambient temperature. Furthermore, an overly high temperature at the interior of the switchboard is likely to cause an overheat failure, breakdown, or short circuit to the switchboard.

As mentioned before, cool air outside the switchboard is guided into the switchboard by the inlet fan. If the switchboard is installed in a workplace which is humid or dusty, moisture or dust is likely to be admitted into the switchboard to cause a breakdown or short circuit to the switchboard or cause the switchboard to rust.

Furthermore, due to the unsatisfactory performance of the overhead cooler and the tray-view cooler in terms of heat dissipation, a large amount of energy is required to cool down the switchboard, thereby resulting in a waste of energy.

Accordingly, it is imperative to provide a switchboard copper busbar heat dissipating device conducive to miniaturization of a switchboard, enhancement of efficiency of heat dissipation of the switchboard, compliance with the Ingress Protection (IP) Ratings of the switchboard (regarding waterproofing and dust-proofing thereof), and avoiding a waste of energy.

### SUMMARY OF THE INVENTION

In view of the aforesaid drawbacks of the prior art, it is an objective of the present invention to provide a switchboard copper busbar heat dissipating device.

In order to achieve the above and other objectives, the present invention provides a switchboard copper busbar heat dissipating device, adapted to dissipate heat from a copper busbar inside a switchboard, comprising: a thermally-conductive electrically-insulating plate having a first surface and a second surface, wherein the first surface connects to the copper busbar; at least a heat pipe having a first end and a second end, the first end connecting to a second surface of the thermally-conductive electrically-insulating plate, and the second end protruding out of the switchboard; and a plurality of cooling fins connected to the second end of the heat pipe and disposed outside the switchboard.

The switchboard copper busbar heat dissipating device further comprises a cooling fan disposed outside the switchboard and corresponding in position to the cooling fins.

The switchboard copper busbar heat dissipating device further comprises an air current speed controller electrically connected to the cooling fan and adapted to control the cooling fan in accordance with a temperature of the heat pipe, wherein the temperature of the heat pipe is sensed by a temperature sensing element. The air current speed controller is a pulse-width modulation (PWM) controller.

The switchboard copper busbar heat dissipating device further comprises an energy converting-storing assembly corresponding in position to the cooling fins and adapted to convert heat energy released from the cooling fins into electrical energy and store the electrical energy.

As regards the switchboard copper busbar heat dissipating device, the thermally-conductive electrically-insulating plate is highly capable of thermal conduction and electrical insulation, wherein the thermally-conductive electrically-insulating plate is a ceramic heat-dissipating plate.

As regards the switchboard copper busbar heat dissipating device, the heat pipe is a sintered powder heat pipe, a mesh heat pipe, or a grooved heat pipe.

In conclusion, the present invention provides a switchboard copper busbar heat dissipating device conducive to miniaturization of a switchboard, enhancement of efficiency of heat dissipation of the switchboard, compliance with the Ingress Protection (IP) Ratings of the switchboard (regarding waterproofing and dust-proofing thereof), and avoiding a waste of energy.

### BRIEF DESCRIPTION OF THE DRAWINGS

Objectives, features, and advantages of the present invention are hereunder illustrated with specific embodiments in conjunction with the accompanying drawings, in which:

FIG. 1 is a cross-sectional view of a switchboard copper busbar heat dissipating device according to the first embodiment of the present invention;

FIG. 2 is a perspective view of the switchboard copper busbar heat dissipating device according to the first embodiment of the present invention;

FIG. 3 is a cross-sectional view of the switchboard copper busbar heat dissipating device according to the second embodiment of the present invention; and

FIG. 4 is a cross-sectional view of the switchboard copper busbar heat dissipating device according to the third embodiment of the present invention.

### DETAILED DESCRIPTION OF THE PREFERRED EMBODIMENTS

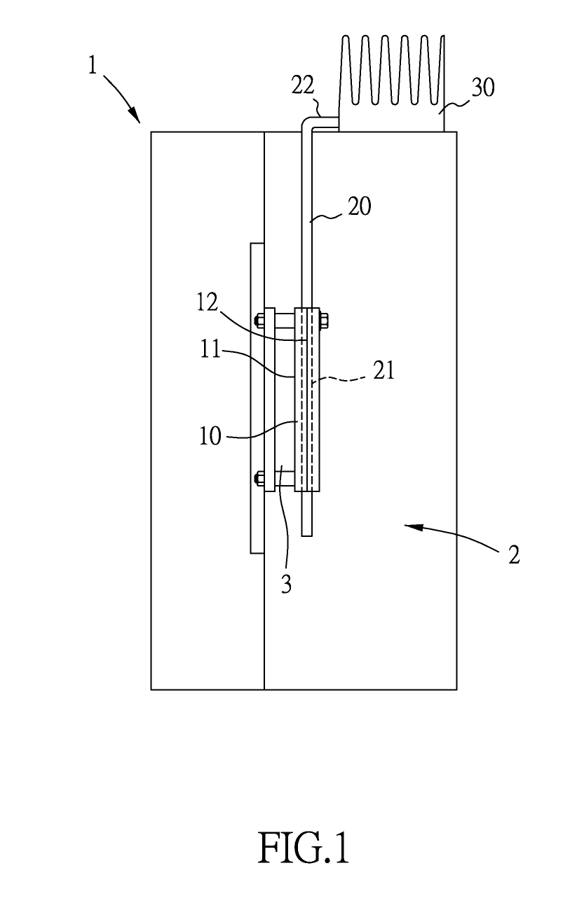

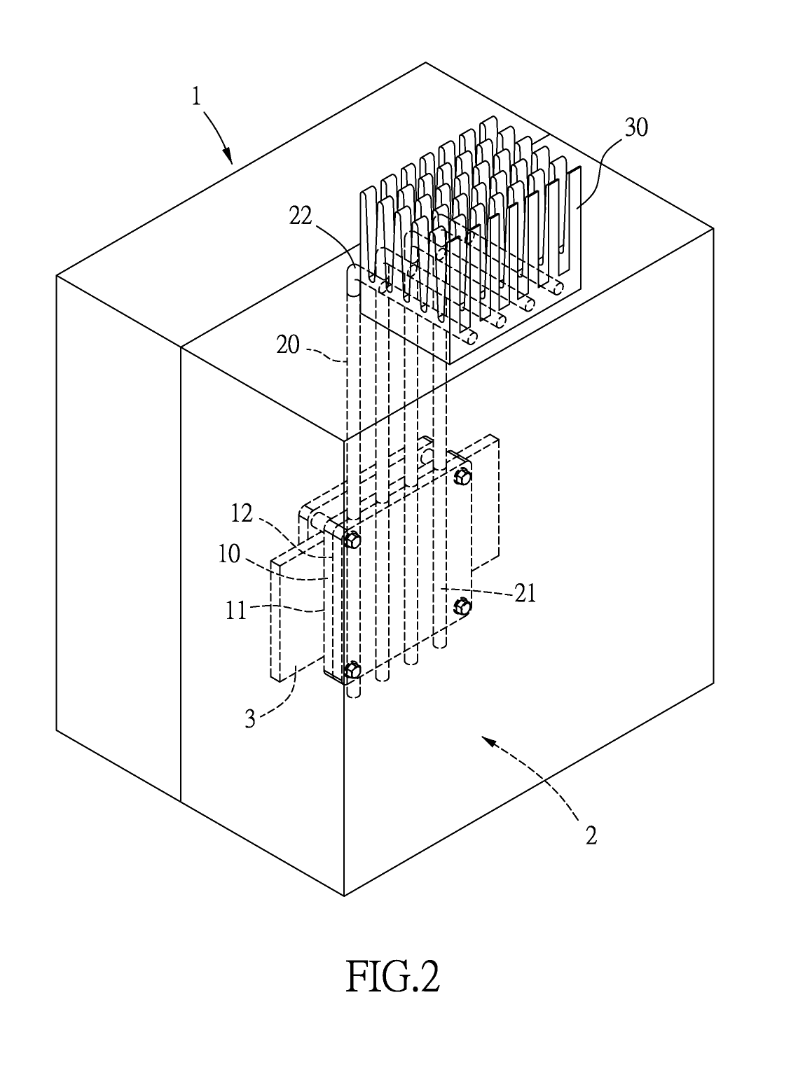

Referring to FIG. 1 and FIG. 2, there are shown a cross-sectional view and a perspective view of a switchboard copper busbar heat dissipating device according to the first embodiment of the present invention, respectively. The switchboard copper busbar heat dissipating device dissipates heat from a copper busbar 3 in a switchboard's interior 2 of a switchboard 1. The switchboard copper busbar heat dissipating device essentially comprises a thermally-conductive electrically-insulating plate 10, at least one heat pipe 20, and a plurality of cooling fins 30. Referring to FIG. 1, at least one copper busbar 3 is disposed in the switchboard's interior 2 of the switchboard 1, but the present invention is not limited thereto, as it is also feasible for the copper busbar 3 to be replaced with an aluminum busbar.

The thermally-conductive electrically-insulating plate 10 has a first surface 11 and a second surface 12. The first surface 11 is connected to the copper busbar 3 by means of a clamping element (not shown) or a fastening element (not shown). Preferably, the thermally-conductive electrically-insulating plate 10 is highly capable of thermal conduction and electrical insulation, and is provided in the form of a ceramic heat-dissipating plate, for example. The heat pipe 20 has a first end 21 and a second end 22. The first end 21 is connected to the second surface 12 of the thermally-conductive electrically-insulating plate 10 by means of a clamping element (not shown), or by locking or welding. The second end 22 lies outside the switchboard 1. The heat pipe 20 is a sintered powder heat pipe, a mesh heat pipe, or a grooved heat pipe. The cooling fins 30 are connected to the second end 22 of the heat pipe 20 and lie outside the switchboard 1. Referring to FIG. 2, the efficiency of heat dissipation effectuated by the heat pipe 20 increases with the quantity thereof.

Referring to FIG. 1 and FIG. 2, the temperature of the copper busbar 3 of the switchboard's interior 2 is ever-increasing while the switchboard 1 is operating, and heat generated from the copper busbar 3 in the switchboard's interior 2 is transferred by the thermally-conductive electrically-insulating plate 10 to the heat pipe 20 and then to the cooling fins 30 by thermal conduction. Eventually, the heat is removed from the switchboard 1 by the cooling fins 30.

In conclusion, the present invention is advantageously characterized in that: the switchboard's interior 2 of the switchboard 1 is effective in effectuating heat dissipation continuously even though it can be less spacious than its conventional counterpart, and thus the switchboard 1 of the present invention can be miniaturized; Furthermore, the heat from the copper busbar 3 is directly removed from the switchboard 1 by thermal conduction, thereby dispensing with an inlet fan and an exhaust fan and dispensing with the need to supply additional electrical power required to start a heat dissipating device, and thereby saving energy. Furthermore, the aforesaid thermal conduction renders instant heat dissipation feasible and attains cooling quicker than convection, and thus is effective in enhancing the efficiency of the heat dissipation of the switchboard. Furthermore, the switchboard copper busbar heat dissipating device of the present invention prevents moisture and dust from being admitted into the switchboard's interior even when the switchboard is operating in a humid or dusty environment, such as a mine, a desert, or an electrostatic zone, thereby complying with the Ingress Protection (IP) Ratings of the switchboard (regarding waterproofing and dust-proofing thereof), and protecting the switchboard against a short circuit, breakdown, rusting, and damage.

The switchboard 1 can come in various forms, such as a high-voltage switchboard and a low-voltage switchboard. Preferably, if the switchboard 1 is a low-voltage switchboard, the thermally-conductive electrically-insulating plate 10 will be a highly thermally-conductive and electrically-insulating plate to thereby preclude a short circuit.

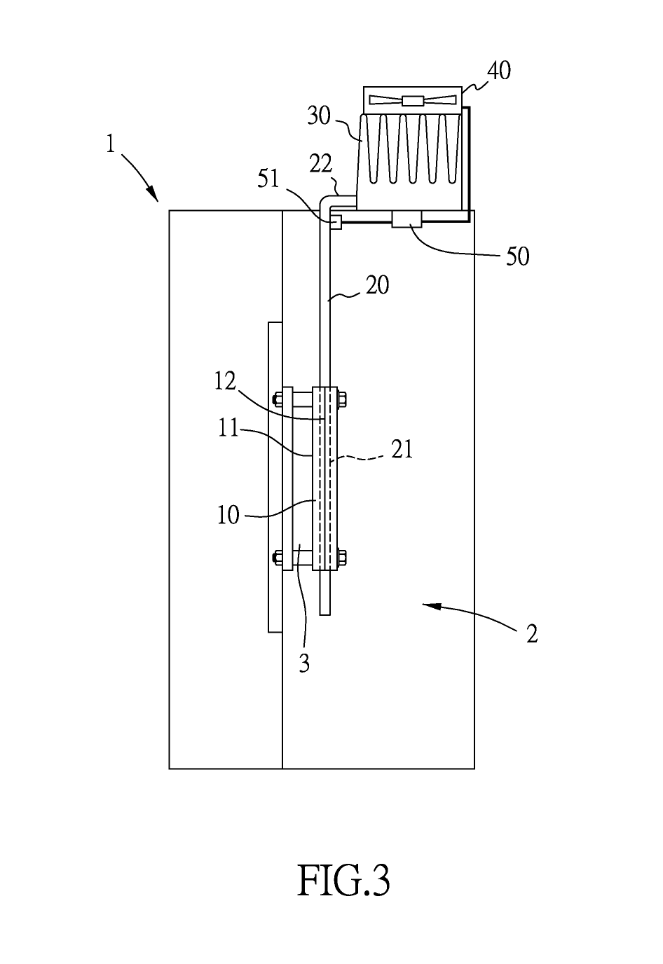

Referring to FIG. 3, there is shown a cross-sectional view of the switchboard copper busbar heat dissipating device according to the second embodiment of the present invention. The switchboard copper busbar heat dissipating device in the second embodiment is substantially identical to the switchboard copper busbar heat dissipating device in the first embodiment. However, unlike the switchboard copper busbar heat dissipating device in the first embodiment, the switchboard copper busbar heat dissipating device in the second embodiment further comprises a cooling fan 40 disposed outside the switchboard 1 and corresponding in position to the cooling fins 30 to speed up the heat dissipation effectuated by the cooling fins 30.

Furthermore, the switchboard copper busbar heat dissipating device further comprises an air current speed controller 50 electrically connected to the cooling fan 40. The air current speed controller 50 controls the rotation speed of the cooling fan 40 in accordance with the temperature of the heat pipe 20. The temperature of the heat pipe 20 is sensed by a temperature sensing element 51. Depending on the temperature thus sensed, the temperature sensing element 51 drives the air current speed controller 50 to control the rotation speed of the cooling fan 40. Specifically speaking, the air current speed controller 50 increases the rotation speed of the cooling fan 40 in response to an increase in the temperature of the heat pipe 20 so as to speed up the heat dissipation taking place at the cooling fins 30, and decreases the rotation speed of the cooling fan 40 in response to a decrease in the temperature of the heat pipe 20 so as to save energy. The air current speed controller 50 is a pulse-width modulation (PWM) controller.

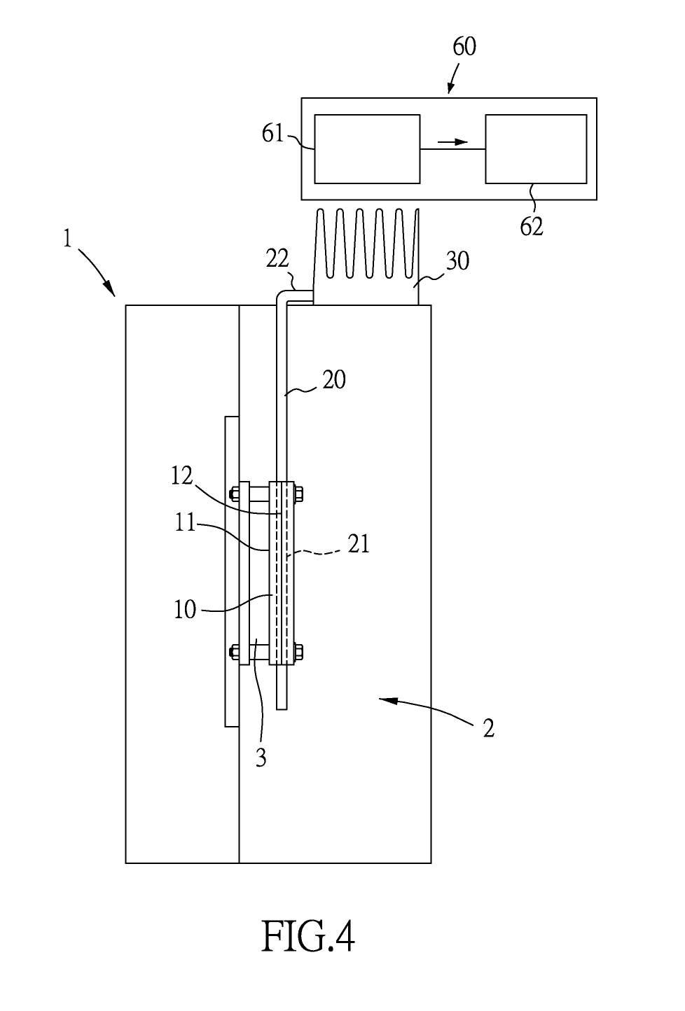

Referring to FIG. 4, there is shown a cross-sectional view of the switchboard copper busbar heat dissipating device according to the third embodiment of the present invention. The switchboard copper busbar heat dissipating device in the third embodiment is substantially identical to the switchboard copper busbar heat dissipating device in the first embodiment. However, unlike the switchboard copper busbar heat dissipating device in the first embodiment, the switchboard copper busbar heat dissipating device in the third embodiment further comprises an energy converting-storing assembly 60 which includes a heat exchange element 61 and an energy storage element 62. The heat exchange element 61 corresponds in position to the cooling fins 30 so as to convert the heat energy released from the cooling fins 30 into electrical energy. Then, the resultant electrical energy is transferred, by a conventional means of transfer, from the heat exchange element 61 to the energy storage element 62 and then stored in the energy storage element 62. The electrical energy stored in the energy storage element 62 is accessible by users for use in supplying electric power to the other devices and apparatuses. Hence, the present invention is effective in achieving heat recycling, environmental protection, and energy saving.

In conclusion, the switchboard copper busbar heat dissipating device of the present invention is conducive to miniaturization, delivery, and installation of the switchboard. Furthermore, the switchboard copper busbar heat dissipating device of the present invention is advantageously characterized in that the heat from the copper busbar is removed from the switchboard by thermal conduction, thereby dispensing the need to supply additional electrical power for starting a heat dissipating device and thus saving energy. Furthermore, the aforesaid thermal conduction renders instant heat dissipation feasible and attains cooling quicker than convection, and thus is effective in enhancing the efficiency of the heat dissipation of the switchboard. Furthermore, the switchboard copper busbar heat dissipating device of the present invention prevents moisture and dust from being admitted into the switchboard's interior even when the switchboard is operating in a humid or dusty environment, thereby complying with the Ingress Protection (IP) Ratings of the switchboard (regarding waterproofing and dust-proofing thereof), and protecting the switchboard against a short circuit, breakdown, rusting, and damage.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A switchboard copper busbar heat dissipating device, for dissipating heat from a copper busbar inside a switchboard, comprising:
a thermally-conductive electrically-insulating plate having a first surface and a second surface, wherein the first surface connects to the copper busbar;
at least a heat pipe having a first end and a second end, the first end connecting to a second surface of the thermally-conductive electrically-insulating plate, and the second end protruding out of the switchboard; and
a plurality of cooling fins connected to the second end of the heat pipe and disposed outside the switchboard.

2. The switchboard copper busbar heat dissipating device of claim 1, further comprising a cooling fan disposed outside the switchboard and corresponding in position to the cooling fins.

3. The switchboard copper busbar heat dissipating device of claim 2, further comprising an air current speed controller electrically connected to the cooling fan and adapted to control the cooling fan in accordance with a temperature of the heat pipe, wherein the temperature of the heat pipe is sensed by a temperature sensing element.

4. The switchboard copper busbar heat dissipating device of claim 3, wherein the air current speed controller is a pulse-width modulation (PWM) controller.

5. The switchboard copper busbar heat dissipating device of claim 1, further comprising an energy converting-storing assembly corresponding in position to the cooling fins and adapted to convert heat energy released from the cooling fins into electrical energy and store the electrical energy.

6. The switchboard copper busbar heat dissipating device of claim 2, further comprising an energy converting-storing assembly corresponding in position to the cooling fins and adapted to convert heat energy released from the cooling fins into electrical energy and store the electrical energy.

7. The switchboard copper busbar heat dissipating device of claim 3, further comprising an energy converting-storing assembly corresponding in position to the cooling fins and adapted to convert heat energy released from the cooling fins into electrical energy and store the electrical energy.

8. The switchboard copper busbar heat dissipating device of claim 4, further comprising an energy converting-storing assembly corresponding in position to the cooling fins and adapted to convert heat energy released from the cooling fins into electrical energy and store the electrical energy.

9. The switchboard copper busbar heat dissipating device of claim 1, wherein the thermally-conductive electrically-insulating plate is highly capable of thermal conduction and electrical insulation.

10. The switchboard copper busbar heat dissipating device of claim 2, wherein the thermally-conductive electrically-insulating plate is highly capable of thermal conduction and electrical insulation.

11. The switchboard copper busbar heat dissipating device of claim 3, wherein the thermally-conductive electrically-insulating plate is highly capable of thermal conduction and electrical insulation.

12. The switchboard copper busbar heat dissipating device of claim 4, wherein the thermally-conductive electrically-insulating plate is highly capable of thermal conduction and electrical insulation.

13. The switchboard copper busbar heat dissipating device of claim 6, wherein the thermally-conductive electrically-insulating plate is a ceramic heat-dissipating plate.

14. The switchboard copper busbar heat dissipating device of claim 1, wherein the heat pipe is one of a sintered powder heat pipe, a mesh heat pipe, and a grooved heat pipe.

15. The switchboard copper busbar heat dissipating device of claim 2, wherein the heat pipe is one of a sintered powder heat pipe, a mesh heat pipe, and a grooved heat pipe.

16. The switchboard copper busbar heat dissipating device of claim 3, wherein the heat pipe is one of a sintered powder heat pipe, a mesh heat pipe, and a grooved heat pipe.

17. The switchboard copper busbar heat dissipating device of claim 4, wherein the heat pipe is one of a sintered powder heat pipe, a mesh heat pipe, and a grooved heat pipe.
